(19) United States
(12) Patent Application Publication
(10) Pub. No.: US 2006/0271654 A1
(43) Pub. Date: Nov. 30, 2006

(54) Network interface unit

(75) Inventors: Ye-youl Lee, Seoul (KR); Chang-yong Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/429,306

(22) Filed: May 8, 2006

(30) Foreign Application Priority Data
May 11, 2005 (KR) 2005-39415

(51) Int. Cl. G06F 15/177

(52) U.S. Cl. 709/221

(57) ABSTRACT

A network interface unit (NIU) based on an expandable home theater (XHT) is provided with a tuner which receives a broadcasting signal over an external network; a demodulator which demodulates a baseband signal from the received broadcasting signal; and an NIU chipset which creates a data signal based on an IEEE 1394 protocol from the baseband signal, and transmits the created signal to an A/V apparatus connected to an internal network. The NIU chipset comprises a POD interface controller which outputs a scrambled transport stream included in the baseband signal, receives an encrypted signal, which is a response to the transmitted transport stream, and decodes the received encrypted signal to restore the transport stream; a de-multiplexer which parses the restored transport stream and de-multiplexes the transport stream to extract a bit stream; and a 1394 module which converts the extracted bit stream into data signals according to the IEEE 1394 protocol.

### CROSS-REFERENCE TO RELATED APPLICATIONS

This application claims all benefits accruing under 35 U.S.C §119 from Korean Patent Application No. 10-2005-0039415 filed on May 11, 2005, in the Korean Intellectual Property Office, the disclosure of which is incorporated by reference herein.

### BACKGROUND OF THE INVENTION

1. Field of the Invention

The present invention relates to a digital apparatus, and more particularly, to a network interface unit (NIU) based on an expandable home theater (XHT).

2. Related Art

In recent years, with significant development in techniques for processing digitalized audio/video (hereinafter, referred to as “A/V”) signals, various A/V apparatuses, such as a digital television, a set-top box, a DVD player, and a digital amplifier, have been installed and used in a home and an office. A remote control unit can be used to easily control these A/V apparatuses. However, the larger the number of A/V apparatuses installed in a predetermined space, the more complicated and difficult in controlling these A/V apparatuses.

Therefore, techniques for operatively integrating a plurality of A/V apparatuses into a single system have been studied, so that a user can easily control the systemized A/V apparatuses. The main object of the study is to connect A/V apparatuses to other A/V apparatuses, via network interfaces, so as to provide a single A/V network system as a whole.

As a part of the study, there has been developed and proposed an expandable home theater (XHT) technique, such as a middleware for A/V home networking. The XHT technique is a home network solution based on a digital television (TV) which has been developed by Samsung Electronics, Co., Ltd., and is adopted as an industry standard by the Consumer Electronics Association (CEA).

According to the XHT technique, a plurality of digital televisions (TVs) as well as A/V apparatuses connected to the digital TVs can be easily controlled using an IEEE 1394 cable (also called “FireWire”) capable of stably transmitting various high-definition-level signals and the Internet protocol (IP), which is a communication protocol mainly used for the Internet. The XHT technique makes it possible for the user to watch the digital TV installed in the bed room, by using a digital broadcasting receiving function of the digital TV installed in the living room.

In addition, an inexpensive network interface unit (NIU) has been developed on the basis of the XHT technique, in the form of a memory card. Such a network interface unit (NIU) can be easily changed according to the reception type of the broadcasting signals, such as, for example, a terrestrial broadcasting signal, a satellite broadcasting signal, and a cable broadcasting signal, which results in a reduction in the cost of communication service providers.

The network interface unit (NIU), a main component composing the XHT together with the digital TV, is a digital apparatus which provides a high-quality video/audio service at low cost, corresponding to the expansion of a built-in digital TV market. The network interface unit (NIU) includes a part of the function of the conventional set-top box, and provides a video/audio streaming service to the digital TV based on the XHT through the IEEE 1394 channel at a cost lower than that of the conventional set-top box.

The conventional network interface unit (NIU) realizes, for example, an open cable, a satellite broadcasting receiving network interface module (NIM), a point of development (POD) interface, a 1394 interface, and a central processing unit (CPU) at the board level. Therefore, there are restrictions to reduce the price of the network interface unit (NIU), as compared with the set-top box. In addition, in order for the digital TV to be available for the general public, an inexpensive network interface unit solution and an NIU chipset having software related to the main functions of the network interface unit (NIU) installed therein must be developed to operate in a simple environment.

Accordingly, there is a need for an inexpensive network interface unit and chipset having software to perform all functions of a network interface unit for a home or office network solution.

### SUMMARY OF THE INVENTION

Several aspects and example embodiments of the present invention provide an NIU chipset having main components of a network interface unit (NIU) integrated therein, and a network interface unit having the NIU chipset mounted thereto.

Additional aspects and/or advantages of the invention will be set forth in part in the description which follows and, in part, will be obvious from the description, or may be learned by practice of the invention.

In accordance with an aspect of the present invention, a network interface unit (NIU) comprises: a tuner which receives a broadcasting signal, via an external network; a demodulator which demodulates a baseband signal from the received broadcasting signal; and an NIU chipset which is formed of a single chipset, creates a data signal on the basis of an IEEE 1394 protocol from the baseband signal, and transmits the created data signal to an A/V apparatus connected to an internal network. The NIU chipset comprises a POD interface controller which outputs a scrambled transport stream included in the baseband signal, receives an encrypted signal, which is a response to the transmitted transport stream, and decodes the received encrypted signal to restore the transport stream; a de-multiplexer which parses the restored transport stream and de-multiplexes the transport stream to extract a bit stream; and a 1394 module which converts the extracted bit stream into data signals according to the IEEE 1394 protocol.

According to an aspect of the present invention, the transport stream is an MPEG-2 (moving picture expert group-2) transport stream, and the bit stream is a video bit stream compressed by the MPEG-2 compression system. In addition, the internal network is an extendable home theater (XHT) network. Further, the A/V apparatus includes a unit which decodes at least the video bit stream.

According to an aspect of the present invention, the network interface unit further includes a memory which is connected to the de-multiplexer and the 1394 module through a PCI bus, receives the extracted bit stream through the PCI bus to temporarily store the received bit stream, and supplies the stored bit stream to the 1394 module through the PCI bus.

According to an aspect of the present invention, device drivers for driving the POD interface controller, the de-multiplexer, and the 1394 module are ported to the NIU chipset.

In accordance with another embodiment of the present invention, a single chipset is provided for generating a data signal on the basis of an IEEE 1394 protocol from a baseband signal. Such a chipset comprises a point of development (POD) interface module arranged to generate a scrambled transport stream included in the baseband signal, and receive an encrypted signal, which is a response to the transmitted transport stream, and to decode the received encrypted signal to restore the transport stream; a de-multiplexer module arranged to parse the restored transport stream and de-multiplex the transport stream to extract a bit stream; and a 1394 module arranged to convert the extracted bit stream into a data signal according to the IEEE 1394 protocol for transmission to an A/V apparatus, via a network.

According to an aspect of the present invention, the POD interface module, the de-multiplexer module and the 1394 module are software modules written to perform respective functions. The chipset is further provided with a memory connected to the de-multiplexer module and the 1394 module, via a bus, to receive the extracted bit stream, via the bus, to temporarily store the received bit stream, and to supply the stored bit stream to the 1394 module, via the bus.

According to an aspect of the present invention, the 1394 module is provided with a transaction layer which performs reading, writing, and locking of asynchronous data; a link layer which has a FIFO (first-in first-out) for temporarily storing the asynchronous data and isochronous data; and a physical layer which transmits the asynchronous data and the isochronous data temporarily stored in the FIFO to the internal network, such that the video bit stream is transmitted as the isochronous data. A DTCP module is further included to encrypt the video bit stream by an encrypting system based on a public key before the video bit stream is transmitted, in order to prevent the illegal duplication of the video bit stream while the video bit stream is being transmitted.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a diagram illustrating the structure of a network interface unit according to an embodiment of the present invention;

FIG. 2 is a diagram schematically illustrating an NIU chipset provided in the network interface unit shown in FIG. 1;

FIG. 3 is a diagram illustrating an example configuration of an MPEG-2 transport stream;

FIG. 4 is a diagram illustrating an example configuration of an MPEG-2 video bit stream;

FIG. 5 is a diagram illustrating the detailed structure of an example 1394 module included in the NIU chipset shown in FIG. 2; and

FIG. 6 is a block diagram illustrating an NIU chipset according to another embodiment of the present invention.

### DETAILED DESCRIPTION OF THE EMBODIMENTS

In general, a network interface unit is connected to parts in a set-top electronic apparatus, via a bus. However, in accordance with the present invention, the network interface unit and the set-top electronic apparatus are separated from each other, and an internal network is arranged therebetween. This arrangement makes it unnecessary to provide the network interface unit (NIU) for each set-top electronic apparatus, and to provide a plurality of set-top electronic apparatuses to a home at a low cost.

In particular, in accordance with aspects of the present invention, a main part of the network interface unit (NIU) is formed of a single NIU chipset, not at a board level. When each module is formed at the board level, the price of each module is increased. Moreover, a lot of time and money are required to process data transmitted from each module through a PCI interface and to develop a device driver for each module. In addition, skilled persons in the expandable home theater (XHT) field are needed to develop and port the device drivers.

Reference will now be made in detail to the present embodiments of the present invention, examples of which are illustrated in the accompanying drawings, wherein like reference numerals refer to the like elements throughout. The embodiments are described below in order to explain the present invention by referring to the figures.

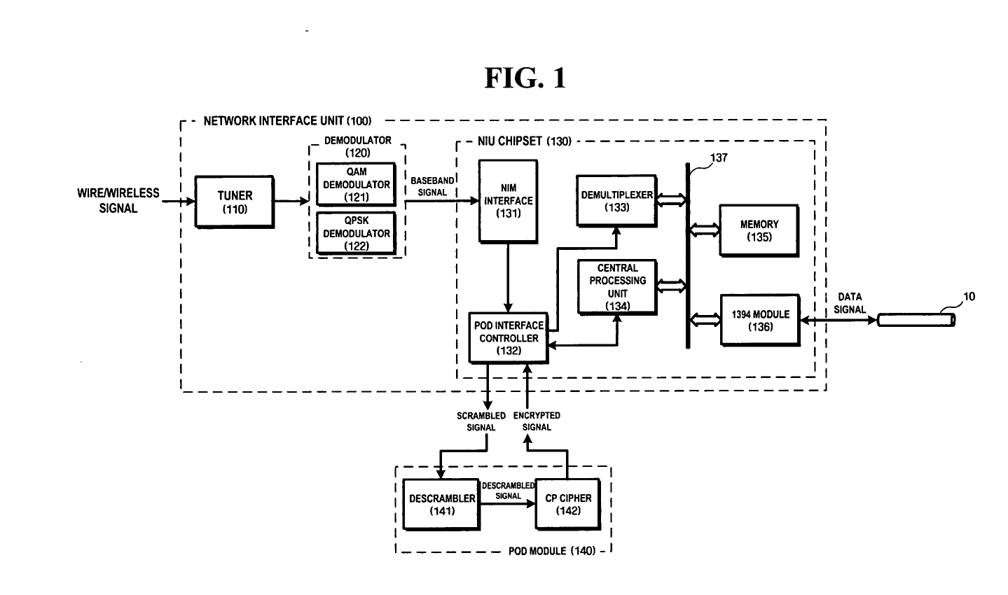

FIG. 1 is a block diagram illustrating the structure of a network interface unit according to an embodiment of the invention. As shown in FIG. 1, the network interface unit (NIU) 100 includes, for example, a tuner 110 for receiving RF (wire/wireless) signals transmitted from an external network such as a broadcasting network; a demodulator 120 having various modulating modes; and a NIU chipset 130. The tuner 110 receives signals selected by a user from wire/wireless signals transmitted from wire/wireless media. For example, the tuner 110 may include an RF antenna for receiving broadcasting signals transmitted through the air, and an intermediate frequency (IF) converting unit for selectively receiving signals in a desired channel among various broadcasting signals and for converting the selected signal into an intermediate frequency (IF) signal. In order to receive cable broadcasting signals, the RF antenna may be replaced with a signal input terminal of a cable modem.

The tuner 110 supplies the intermediate-frequency (IF) signal to the demodulator 120 for demodulation. Then, the demodulator 120 removes a frequency offset, a phase jitter, and an interference between symbols due to a multi-path from the intermediate-frequency signal and restores a baseband signal by a predetermined demodulating method (for example, VSB-8, VSB-16, QAM64, QAM256, QAM1024, DPSK, and QPSK). The restored baseband signal is then supplied to the NIU chipset 130. The baseband signal may be one of various types of data signals, such as a compressed video signal, a compressed audio signal, and a compressed graphic signal. However, for purposes of brevity and simplicity, the baseband signal will be referred to as an MPEG-2 transport stream.

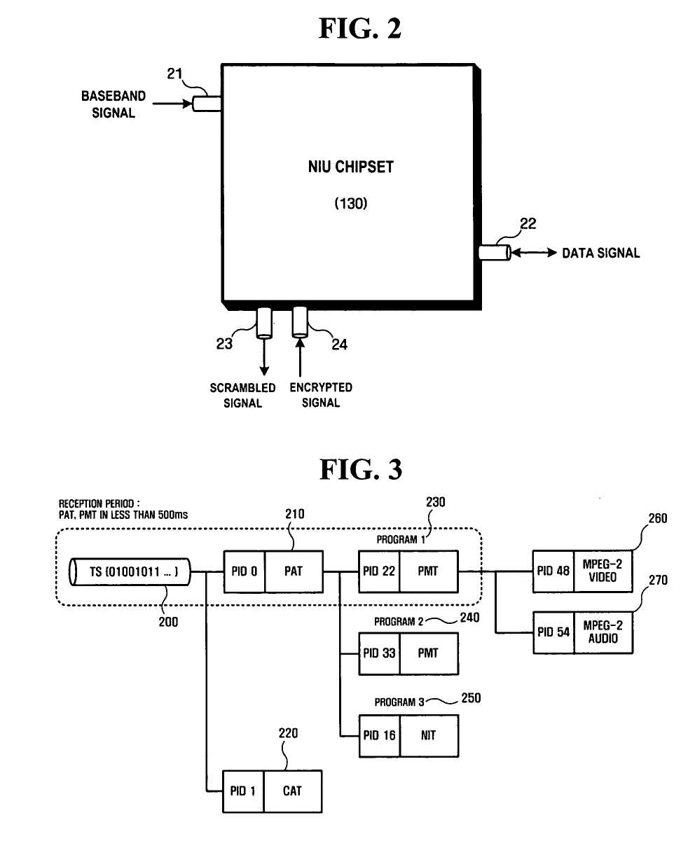

The NIU chipset 130 receives the baseband signal to create a data signal based on an IEEE 1394 standard protocol. FIG. 2 is a diagram schematically illustrating an example NIU chipset 130 according to an embodiment of the present invention. As shown in FIG. 2, the NIU chipset 130 includes, for example, a terminal 21 for receiving the baseband signal from the demodulator 120; two terminals 23 and 24 connected to a conditional access system (CAS), such as an external point of development (POD) system; and a terminal 22 connected to an IEEE 1394 cable 10, as shown in FIG. 1.

A scrambled MPEG-2 transport stream is then output to the external POD system through the terminal 23, and the signal scrambled and encrypted by the external POD system is input to the terminal 24. The terminals 23 and 24 may be realized by, for example, a personal computer memory card international association (PCMCIA) system. The PCMCIA represents an association for standardizing the size of a memory card and an input/output device such that they can be used for a notebook computer or standards defined by the association.

Referring to FIG. 1 again, the components of the NIU chipset 130 will be described in detail herein below. The baseband signal output from the demodulator 120, that is, the MPEG-2 transport stream is input to a network interface module (NIM) interface 131. The NIM interface 131 receives various types of signals output from the demodulator 120 to interface the signals such that the NIU chipset 130 can use the signals.

The MPEG-2 transport stream input to the NIM interface 131 is transmitted to a POD interface controller 132. The POD interface controller 132 is a device for controlling interface with an external POD module 140. The POD interface controller 132 transmits the MPEG-2 transport stream to the POD module 140 through the output terminal 23 (FIG. 2), and receives encrypted signals from the POD module 140 through the input terminal 24 (FIG. 2). Since the MPEG-2 transport stream, which is the baseband signal, is scrambled in a broadcasting output state and is then output therefrom, the MPEG-2 transport stream is in a scrambled state. Therefore, it is difficult to directly demultiplex the MPEG-2 transport stream in this stage, and thus it is necessary for the external POD module 140 to perform a scramble process on the MPEG-2 transport stream.

The POD module 140 is connected to the NIU chipset 130 by the PCMCIA system. In general, in order to operate the POD module 140, the user should insert a smart card issued by a content provider. The POD module 140 includes a descrambler 141 and an integrated copy-protection (CP) cipher 142. The POD module 140 receives the scrambled signal from the NIU chipset 130 and descrambles the received signal using a descrambler 141. Then, the descrambled signal, that is, the original signal is encrypted by the copy-protection (CP) cipher 142. The encrypted signal is transmitted to the NIU chipset 130 again. The descrambled signal is encrypted again so as to prevent an authorized user from reading the content of the signal even when the authorized user intercepts the signal being transmitted from the POD module 140 to the NIU chipset 130.

The POD interface controller 132 receives the encrypted signal from the POD module 140 and decodes the received signal using an integrated copy-protection (CP) decipher (not shown) to restore the MPEG-2 transport stream which is not encrypted. Then, the POD interface controller 132 supplies the restored signal to a de-multiplexer 133 included in the NIU chipset 130.

The de-multiplexer 133 parses and de-multiplexes the supplied MPEG-2 transport stream under the control of a central processing unit (CPU) 134 to extract video and audio signals.

Turning now to FIG. 3, an example MPEG-2 transport stream (TS) 200 according to an embodiment of the present invention is illustrated. As shown in FIG. 3, an MPEG-2 transport stream 200 is composed of a plurality of transport packets each having a fixed length of 188 bites. Each of the transport packets is composed of a 4-bite packet header and a 184-bite data area. The packet header includes, for example, 8-bit synchronous information and a packet identifier (PID) having a binary value of 13 bits.

A video packet 260, an audio packet 270, and a program specific information (PSI) data packet are included in the transport packets. The PSI includes transport packets, such as a program association table (PAT) 210, program map tables (PMPs) 230 and 240 corresponding to programs, for example, program #1, program #2, and a network information table (NIT) 250 corresponding to program #3. When a restricted reception of broadcasting, such as charged broadcasting, is needed, a transport packet, called a conditional access table (CAT) 220, may be used. A unique PID is allocated to each transport packet. The kind of data stored in the data area of the transport packet can be identified by the unique PID. However, in case of the PAT 210, the PID is fixed to zero (0).

Information on the corresponding programs is written in the PAT 210 and PMTs 230 and 240, and different information is entered therein for every channel. However, the program numbers and the channel numbers of all the programs currently being serviced as well as the program broadcasted through the corresponding channel are written in the NIT 250.

However, when the corresponding channel does not receive the PAT 210 and the PMTs 230 and 240, other transport packets do not work. Therefore, in general, the PAT 210 and the PMTs 230 and 240 are received at predetermined time intervals.

Next, the de-multiplexing operation performed by the de-multiplexer 133 included in the NIU chipset 130 will be described below.

First, the de-multiplexer 133 searches the transport packet whose packet identifier (PID) is “0” among all transport packets in the MPEG-2 transport stream 200 and reads out the data area thereof, that is, the program association table (PAT). The PAT includes the program map tables (PMTs) for various programs and the packet identifiers (PIDs) thereof. In a case in which a program No. 1 is selected, when the reading of the PAT shows that the PID of the program No. 1 is “22”, the de-multiplexer 133 searches a transport packet whose PID is “22” among the transport packets which are subsequently received and reads out the data area thereof, that is, the PMT thereof. The reading of the PMT makes it possible to know the PID of the transport packet including the video and audio data of the corresponding program. That is, it possible to know that the video data of the program No. 1 has a PID of “48” and the audio data thereof has a PID of “54” by the reading of the MPT. Therefore, among the transport packets subsequently received, transport packets having a PID of “48” constitute an MPEG-2 video bit stream, and transport packets having a PID of “54” constitute an MPEG-2 audio bit stream 200.

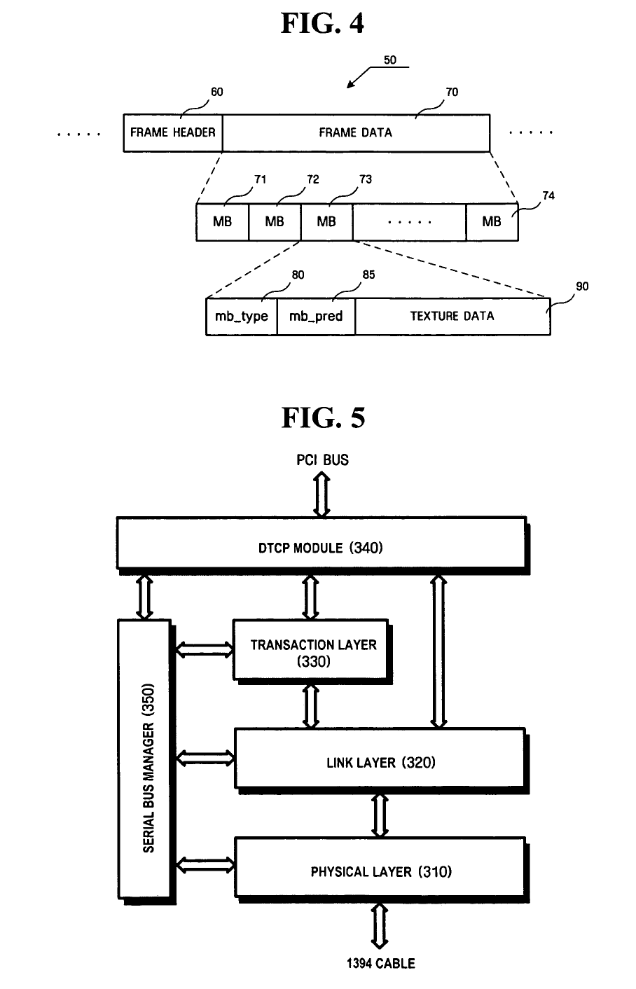

FIG. 4 shows an example structure of the MPEG-2 video bit stream according to an embodiment of the present invention. In accordance with the MPEG-2 standard, video signals are encrypted in units of frames. Therefore, each bit stream 50 includes a frame header 60 and frame data 70. The frame data 70 comprises a plurality of macro-block data 71 to 74. In addition, the macro-block data 73 may be composed of an mb_type field 80, an mb_pred field 85, and a texture data field 90.

A value indicating the kind of macroblock is recorded in the mb_type field 80. That is, a value indicating whether the current macroblock is an intra macro-block or an inter macro-block is recorded in the mb_type field 80. A detailed predictive mode according to the kind of macro-block is recorded in the mb_pred field 85. If the current macro-block is the intra macro-block, the selected intra predictive mode is recorded. On the other hand, if the current macro-block is the inter macro-block, a macro-block partition separate reference frame number and a motion vector are recorded.

Further, encrypted texture data is recorded in the texture data field 90. Referring back to FIG. 1, the video bit stream and the audio bit stream extracted by the de-multiplexer 133 can be temporarily stored in a memory 135, via a PCI bus 137. The stored bit streams are supplied to a 1394 module 136, via the PCI bus 137. Then, the 1394 module 136 converts the bit streams into data signals according to the IEEE 1394 protocol and supplies the converted signals to another A/V apparatus within the XHT network.

An EIDE, which is an interface of an auxiliary storage unit currently being used, is operated at low speed and is restricted in expansion. The SCSI system has a high degree of expansion, but is expensive. In addition, since the standard of the SCSI system is minimally defined, the protocols and drivers provided by manufacturers are slightly different from each other. In the SCSI system, expansion can be easily made from the theoretical point of view, but there is a difficulty in use due to the difference between characteristics of peripheral apparatuses in practice. Therefore, the IEEE 1394 standard has been developed to overcome the above-mentioned problems and to connect the peripheral apparatuses (particularly, high-speed peripheral apparatuses) with one cable. The IEEE 1394 standard is a series system, but is a digital interface. Therefore, in the IEEE 1394 standard, it is possible to transmit or receive digital data without conversion, and thus to reduce the loss of data.

Turning now to FIG. 5, a detailed structure of an example 1394 module 136 is shown. The 1394 module 136 includes a physical layer 310, a link layer 320, a transaction layer 330, and a serial bus manager 350. The serial bus manager 350 is connected to three layers, that is, the physical layer 310, the link layer 320, and the transaction layer 330. The physical layer 310 is connected to an IEEE 1394 cable 10, as shown in FIG. 1, and the other layers are connected to applications.

The serial bus manager 350 performs the adjustment of timing, the supply of power to all devices, and the management of all serial buses, and assigns functions, such as cycle masters, isochronous identifiers (IDs), and error recognition, to the layers. The serial bus manager 350 may be formed of a register structure according to the IEEE 1212 standard.

The transaction layer 330 functions to read, write, and lock an asynchronous protocol. In the writing of the asynchronous protocol, data is transmitted from a transmitter side to a receiver side. In the reading of the asynchronous protocol, data is transmitted from the receiver side to the transmitter side. As a combination of the writing and the reading, the locking function means retransmitting data after the transmission of data to another transmitter side, when the receiver side and the transmitter side communicate with each other.

The link layer 320 includes two FIFOs (first-in first-out) for transmitting/receiving synchronous and isochronous transport packets and one receiving FIFO. Each of the FIFOs has a length of 32 bits and the user can determine software on the basis of the size of the FIFO. The asynchronous FIFO for transmission and the isochronous FIFO is used for writing, and the FIFO for reception is used for reading. In the asynchronous transmission, data and layer information are transmitted to a specified address, and the asynchronous transmission is used to transmit information to an apparatus required to be operated in real time, such as a printer or a scanner. In the isochronous transmission, data including a channel number, not an address, is transmitted. That is, although errors occur, retransmission is not required in order for real-time transmission. The isochronous transmission makes it possible to transmit the video stream or the audio stream temporarily stored in the memory 135 to other A/V apparatuses, such as, for example, digital TVs and DV video cameras.

The physical layer 310 is electrically and physically connected between the IEEE 1394 device and the cable, and functions as a repeater for actually transmitting/receiving data, for allowing all devices to sequentially perform the bus, and for providing the same function to the ports.

When a new peripheral apparatus is added to the network or the existing apparatus is separated from the network while the components 310, 320, 330, and 350 of the 1394 module are being operated, the configuration of the network is readjusted. At that time, the information transmitted over the network is initialized, and the entire network is dynamically reconfigured. The addressees are reallocated to the nodes. In this case, if necessary, the node which is most frequently used may be forcibly designated as a route. After the configuration of the route node is completed, each node notifies other nodes of existence thereof. After information on all of the nodes is collected in this way, the IEEE 1394 interface is ready to start a normal operation.

Further, in accordance with an embodiment of the invention, the 1394 module 136 may further include a DTCP (data transmission content protection) module 340 satisfying the DTCP standard for preventing illegal duplication of entertainment contents during transmission and reproduction. The DTCP is referred to as a so-called “5C” which is a technique used to encrypted data and transmit the encrypted data, on the basis of an encoding algorithm, AKE (authentication and key exchange), and a public key encrypting technique.

In accordance with the embodiment of the invention, the bit stream transmitted from the memory 136, via the PCI bus 137, is encrypted by the DTCP module 340 and is then supplied to the serial bus manager 350, the transaction layer 330, or the link layer 320. Similarly, data received from the above-mentioned layers is decoded by the DTCP module 340.

Referring back to FIG. 1, the 1394 module 136 encrypts the bit stream stored in the memory 136 through the procedure described in FIG. 5, and converts the same into data signals according to the IEEE 1394 protocol. Then, the 1394 module 136 transmits the data signals to other A/V apparatuses through the IEEE 1394 cable 10, as shown in FIG. 1.

Meanwhile, the central processing unit (CPU) 134 controls all components of the NIU chipset 130 and may be formed of, for example, a a micro-processor. The central processing unit (CPU) 134 is connected to the PCI bus 137 to transmit signals for controlling the de-multiplexer 133, the memory 135, and the 1394 module 136, via the PCI bus 137, and to receive response signals from the components.

The operating system (OS) for operating the process of the central processing unit (CPU) 134 and device drivers for driving the other components of the NIU chipset 135 are ported to the NIU chipset 130.

The data signals are transmitted from the network interface unit (NIU) 100 to an A/V apparatus connected to the XHT network, such as a digital TV, via the IEEE 1394 cable, and are then converted into the video data or the audio data by the A/V apparatus. The A/V apparatus is provided with, for example, an MPEG-2 decoder, to decode the audio stream or the video stream included in the data signals. The decoded signals are converted into signals having a format (for example, NTSC, SVideo, and DVI) suitable for a visual display, such as a digital TV, by a signal output unit.

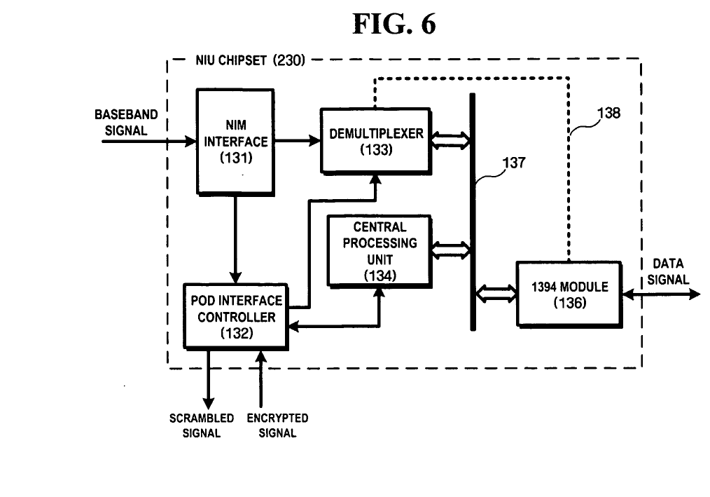

FIG. 6 is a block diagram illustrating the configuration of an NIU chipset 230 according to another embodiment of the invention. In the example embodiment shown in FIG. 1, the de-multiplexer 133 and the 1394 module 136 are connected to each other, via the PCI bus 137. The bit stream created by the de-multiplexer 133 is stored in the shared memory 135 and is then transmitted to the 1394 module 136, via the PCI bus 137.

Unlike the example embodiment shown in FIG. 1, the de-multiplexer 133 is directly connected to the 1394 module 136 by a synchronized hardwired connection 138, as shown in FIG. 6, and the central processing unit (CPU) 134 controls the transmission of data from the de-multiplexer 133 to the 1394 module 136, via the PCI bus 137. In the example configuration shown in FIG. 6, the PCI bus 137 is used only for the central processing unit (CPU) 134 to transmit signals for controlling the components and to receive the response signals therefrom, but does not function as a path for transmitting data.

The use of the hardwired system causes the signals output from the de-multiplexer 133 to be directly transmitted to the 1394 module 136 without passing through the memory 135, which makes it possible to simplify the structure of the system, to raise the transmission speed, and to reduce the manufacturing costs of the NIU chipset 230. However, in order to directly connect the de-multiplexer 133 to the 1394 module 136 by the hardwired connection 138, it is premised that synchronization for between the de-multiplexer 133 and the 1394 module 136 can be made for data transmission. Therefore, it is desirable that the NIU chipset 230, as shown in FIG. 6, be used in an environment in which data is transmitted from the 1394 module 136 to the XHT network at a predetermined transmission rate or more.

Previously, when a network interface unit is formed at the board level, a lot of time and money are required to develop and port device drivers for modules included in the network interface unit, and skilled persons in the XHT field are needed to develop and port the device drivers. However, as described above, according to the invention, a network interface unit (NIU) is formed of a single chipset, which makes it possible to reduce the manufacturing costs of the network interface and to shorten the time required to develop the network interface unit (NIU).

Various components of the network interface unit 100, such as the tuner 110, the demodulator 120 and the NIU chipset 130, as shown in FIG. 1, FIG. 2 and FIG. 6, can be implemented in software or hardware, such as, for example, an application specific integrated circuit (ASIC). As such, it is intended that the processes described herein be broadly interpreted as being equivalently performed by software, hardware, or a combination thereof. Software modules can be written, via a variety of software languages, including C, C++, Java, Visual Basic, and many others. The various software modules may also be integrated in a single application executed on various types of wireless cards, such as PCMCIA cards, PCI cards, USB card. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the components of the network interface unit (NIU) can be implemented in a single hardware or firmware stalled at an existing card to perform the functions as described. In addition, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, both the software modules can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Lastly, the network interface unit (NIU) can also be implemented in a single ASIC chip installed at any A/V apparatus, such as a digital TV, PDP, LCD monitors and audio receiver. Accordingly, it is intended, therefore, that the present invention not be limited to the various example embodiments disclosed, but that the present invention includes all embodiments falling within the scope of the appended claims.

What is claimed is:

1. A network interface unit comprising:
a tuner which receives a broadcasting signal, via an external network;
a demodulator which demodulates the broadcasting signal to generate a baseband signal; and
a chipset which creates a data signal on the basis of an IEEE 1394 protocol from the baseband signal, and transmits the created data signal to an A/V apparatus connected to an internal network, the chipset comprising:
a POD interface controller which outputs a scrambled transport stream included in the baseband signal, receives an encrypted signal, which is a response to the transmitted transport stream, and decodes the received encrypted signal to restore the transport stream;
a de-multiplexer which parses the restored transport stream and de-multiplexes the transport stream to extract a bit stream; and
a 1394 module which converts the extracted bit stream into data signals according to the IEEE 1394 protocol.

2. The network interface unit according to claim 1, wherein the transport stream is an MPEG-2 (moving picture expert group-2) transport stream, and wherein the bit stream is a video bit stream compressed in accordance with a MPEG-2 compression standard.

3. The network interface unit according to claim 2, wherein the internal network is an extendable home theater (XHT) network.

4. The network interface unit according to claim 3, wherein the A/V apparatus includes a unit which decodes at least the video bit stream.

5. The network interface unit according to claim 1, further comprising:
a network interface module (NIM) interface which receives various signals from the demodulator and interfaces the signals such that the chipset uses the signals.

6. The network interface unit according to claim 1, wherein the received encrypted signal is obtained by descrambling the transport stream and by encrypting the descrambled signal according to a predetermined encoding system.

7. The network interface unit according to claim 4, further comprising:
a memory connected to the de-multiplexer and the 1394 module, via a PCI bus, to receive the extracted bit stream, via the PCI bus to temporarily store the received bit stream, and to supply the stored bit stream to the 1394 module, via the PCI bus.

8. The network interface unit according to claim 7, wherein the 1394 module comprises:
a transaction layer which performs reading, writing, and locking of asynchronous data;
a link layer which has a FIFO (first-in first-out) for temporarily storing the asynchronous data and isochronous data; and
a physical layer which transmits the asynchronous data and the isochronous data temporarily stored in the FIFO to the internal network,
wherein the video bit stream is transmitted as the isochronous data.

9. The network interface unit according to claim 8, wherein the 1394 module further comprises a DTCP module which encrypts the video bit stream by an encrypting system based on a public key before the video bit stream is transmitted, in order to prevent the illegal duplication of the video bit stream while the video bit stream is being transmitted.

10. The network interface unit according to claim 4, wherein device drivers for driving the POD interface controller, the de-multiplexer, and the 1394 module are ported to the NIU chipset.

11. The network interface unit according to claim 4, wherein the transport stream output by the de-multiplexer is transmitted to the 1394 module through a hardwired connection.

12. The network interface unit according to claim 4, wherein the signal is input to or output from the POD interface controller by a PCMCIA (personal computer memory card international association) system.

13. A chipset for generating a data signal on the basis of an IEEE 1394 protocol from a baseband signal, the chipset comprising:
a point of development (POD) interface module arranged to generate a scrambled transport stream included in the baseband signal, and receive an encrypted signal, which is a response to the transmitted transport stream, and to decode the received encrypted signal to restore the transport stream;
a de-multiplexer module arranged to parse the restored transport stream and de-multiplex the transport stream to extract a bit stream; and
a 1394 module arranged to convert the extracted bit stream into a data signal according to the IEEE 1394 protocol for transmission to an A/V apparatus, via a network.

14. The chipset according to claim 13, wherein the POD interface module, the de-multiplexer module and the 1394 module are software modules written to perform respective functions.

15. The chipset according to claim 13, wherein the transport stream is an MPEG-2 (moving picture expert group-2) transport stream, and wherein the bit stream is a video bit stream compressed in accordance with a MPEG-2 compression standard, and the network is an extendable home theater (XHT) network.

16. The chipset according to claim 13, wherein the received encrypted signal is obtained by descrambling the transport stream and by encrypting the descrambled signal according to a predetermined encoding system.

17. The chipset according to claim 13, further comprising:
a memory connected to the de-multiplexer module and the 1394 module, via a bus, to receive the extracted bit stream, via the bus, to temporarily store the received bit stream, and to supply the stored bit stream to the 1394 module, via the bus.

18. The chipset according to claim 13, wherein the 1394 module comprises:
a transaction layer which performs reading, writing, and locking of asynchronous data;
a link layer which has a FIFO (first-in first-out) for temporarily storing the asynchronous data and isochronous data; and
a physical layer which transmits the asynchronous data and the isochronous data temporarily stored in the FIFO to the internal network, wherein the video bit stream is transmitted as the isochronous data.

19. The chipset according to claim 18, wherein the 1394 module further comprises a DTCP module which encrypts the video bit stream by an encrypting system based on a public key before the video bit stream is transmitted, in order to prevent the illegal duplication of the video bit stream while the video bit stream is being transmitted.
